(19) United States
(12) Patent Application Publication
(10) Pub. No.: US 2024/0195032 A1
(43) Pub. Date: Jun. 13, 2024

(54) ELECTRODE BODY AND RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Takashi NAKAZONO, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/529,809

(22) Filed: Dec. 5, 2023

(30) Foreign Application Priority Data
Dec. 9, 2022 (JP) 2022-197129

(51) Int. Cl. H01M 50/586; H01M 4/13; H01M 10/0525; H01M 50/59

(52) U.S. Cl. CPC H01M 50/586; H01M 4/13; H01M 10/0525; H01M 50/59; H01M 2004/028

(57) ABSTRACT

An electrode body includes a substrate serving as a collector, a mixture layer formed on the substrate and containing an electrode active material, and an insulation layer formed on the substrate adjacent to the mixture layer. The insulation layer contains an insulative material. In an interfacial region of the mixture layer and the insulation layer, the mixture layer extends over and overlaps the insulation layer that covers a surface of the substrate. Further, an interfacial surface of the insulation surface interfacing the mixture layer includes undulations having an undulation width that is greater than a particle size of the electrode active material.

### BACKGROUND

### 1. Field

The present disclosure relates to an electrode body and a rechargeable battery.

### 2. Description of Related Art

An electrode body of a rechargeable battery includes a substrate, which serves as a collector, and a mixture layer, which is formed on the substrate and contains an electrode active material. The substrate of such an electrode body includes a portion at one end that is not coated with the electrode active material. The uncoated portion is connected to an electrode terminal. Japanese Laid-Open Patent Publication No. 2015-76196 describes an example of an electrode body that includes an insulation layer containing an insulative material. The insulation layer is formed on the substrate in the uncoated portion adjacent to the mixture layer.

### SUMMARY

In the electrode body of the structure described above, the edge of the mixture layer tends to delaminate from the substrate. Thus, it is significant that the adhesion strength be high at the edge of the mixture layer, which is the interfacial region between the mixture layer and the insulation layer.

An electrode body according to one aspect of the present disclosure includes a substrate serving as a collector, a mixture layer formed on the substrate and containing an electrode active material, and an insulation layer formed on the substrate adjacent to the mixture layer. The insulation layer contains an insulative material. In an interfacial region of the mixture layer and the insulation layer, the mixture layer extends over and overlaps the insulation layer that covers a surface of the substrate. Further, an interfacial surface of the insulation surface interfacing the mixture layer includes undulations having an undulation width that is greater than a particle size of the electrode active material.

In the electrode body, the undulation width ranges from 5 to 30 times the particle size.

In the above electrode body, the undulation width ranges from 20 to 120 μm, inclusive.

In the above electrode body, the undulations occupy 20% or more of the interfacial surface.

In the above electrode body, the insulation layer has a thickness at troughs of the undulations that is greater that the particle size of the insulative material.

In the above electrode body, the undulations are arranged within a range of 200 μm from a distal end of the mixture layer extending over and overlapping the insulation layer.

In the above electrode body, the mixture layer is a positive electrode active material layer.

A rechargeable battery according to a further aspect of the present disclosure includes the above body electrode.

### BRIEF DESCRIPTION OF THE DRAWINGS

FIG. 1 is a perspective view of a rechargeable battery.

FIG. 2 is an exploded view of an electrode body.

FIG. 3 is a side view of the rechargeable battery.

FIG. 4 is a cross-sectional view of a mixture layer and an insulation layer that are formed on a substrate.

FIG. 5 is an enlarged cross-sectional view showing the stack of the mixture layer and the insulation layer in an interfacial region.

FIG. 6 is a schematic diagram showing an interfacial surface in a comparative example having a narrow undulation width.

FIG. 7 is a graph illustrating the relationship of the undulation width and the adhesion strength.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment of a rechargeable battery and its electrode body will now be described with reference to the drawings.

### Rechargeable Battery

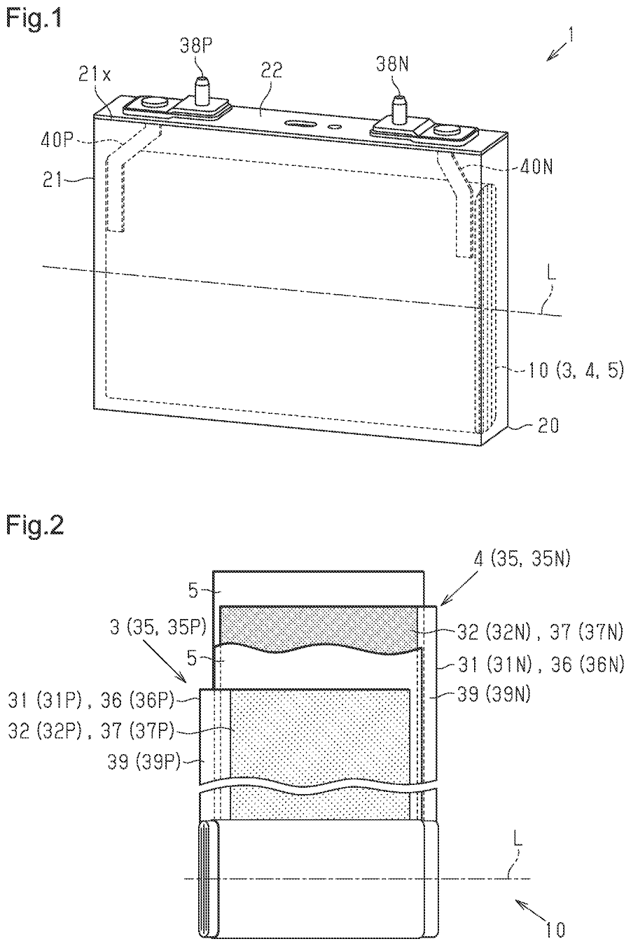

As shown in FIG. 1, a rechargeable battery 1 includes an electrode body 10 and a case 20 accommodating the electrode body 10. The electrode body 10 integrates a positive electrode 3, a negative electrode 4, and separators 5. In the rechargeable battery 1 of the present embodiment, the electrode body 10 is immersed in a non-aqueous electrolyte solution (not shown) inside the case 20.

In the rechargeable battery 1 of the present embodiment, the positive electrode 3, the negative electrode 4, and the separators 5 are sheets that are stacked one upon another. The stack of the positive electrode 3, the negative electrode 4, and the separators 5 is rolled with the separators 5 held between the positive electrode 3 and the negative electrode 4 to form the electrode body 10 so that the positive electrode 3, the negative electrode 4, and the separator 5 are arranged in an alternating manner in the radial direction of the rolled stack.

The case 20 of the present embodiment includes a case body 21, which has the form of a flattened box, and a lid 22, which closes an open end 21x of the case body 21. The electrode body 10 of the present embodiment has a flattened form and is shaped in conformance with the box-shaped case 20.

### Electrode Sheet and Electrode Body

As shown in FIG. 2, in the rechargeable battery 1 of the present embodiment, the positive electrode 3 and the negative electrode 4 are each formed by an electrode sheet 35 including a collector 31, which has the form of a sheet, and electrode active material 32, which is applied to the collector 31.

More specifically, an electrode sheet 35P of the positive electrode 3 is formed by applying a mixture paste 37P, which contains lithium transition metal oxide that serves as the positive electrode active material, to a substrate 36P, which is formed from aluminum or the like and serves as a positive electrode collector 31P. An electrode sheet 35N of the negative electrode 4 is formed by applying a mixture paste 37N, which contains carbon material that serves as the negative electrode active material, to a substrate 36N, which is formed from copper or the like and serves as the negative electrode collector 31N. The mixture pastes 37P and 37N each include a binder. In the rechargeable battery 1 of the present embodiment, the mixture pastes 37P and 37N are dried to form a positive electrode active material layer 32P and a negative electrode active material layer 32N on the corresponding positive and negative electrode sheets 35P and 35N.

Further, in the rechargeable battery 1 of the present embodiment, the positive and negative electrode sheets 35P and 35N are shaped as strips. In the electrode body 10 of the present embodiment, the stack of the positive and negative electrode sheets 35P and 35N and the separators 5 held in between is rolled about a rolling axis L extending in the widthwise direction of the strips (lateral direction in FIG. 2).

In FIG. 2, the separators 5 and the electrode sheets 35 are rolled with the electrode sheet 35P of the positive electrode 3 arranged at the inner side. The drawing shows one example of the structure of the electrode body 10. Thus, the separators 5 and the electrode sheets 35 may be rolled with the electrode sheet 35N of the negative electrode 4 arranged at the inner side. This determines whether the electrode sheet 35 arranged at the outermost part of the electrode body 10 is the electrode sheet 35P forming the positive electrode 3 or the electrode sheet 35N forming the negative electrode 4.

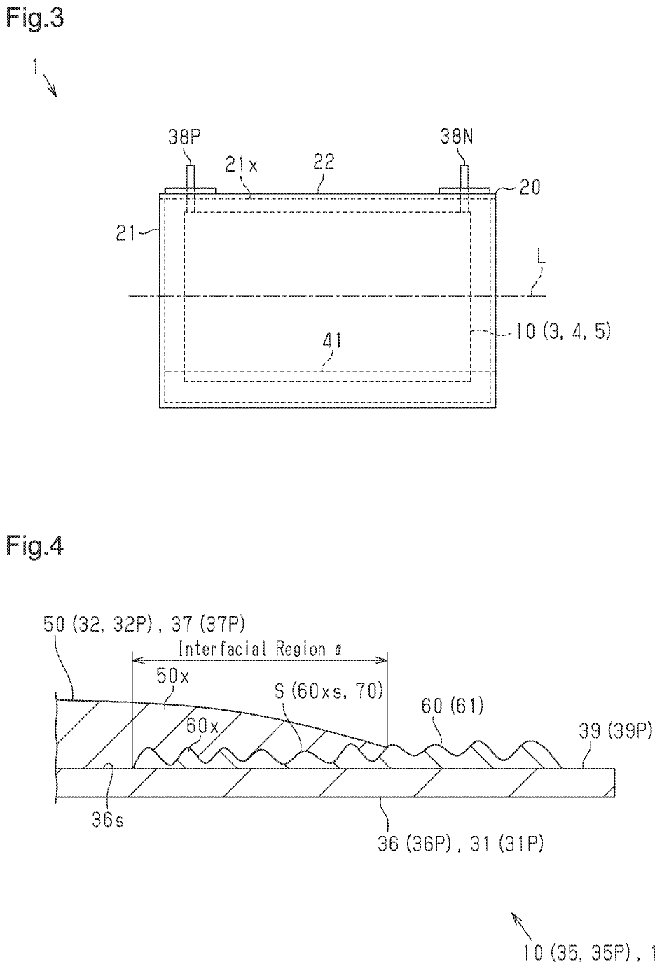

As shown in FIGS. 1 to 3, the lid 22 of the case 20 includes a positive electrode terminal 38P and a negative electrode terminal 38N that project outward from the case 20. Further, the collector 31 of each electrode sheet 35 includes an uncoated portion 39 where the electrode active material layer 32 is not applied. In the rechargeable battery 1 of the present embodiment, the uncoated portion 39 electrically connects the electrode sheet 35P of the positive electrode 3 to the positive electrode terminal 38P or the electrode sheet 35N of the negative electrode 4 to the negative electrode terminal 38N.

The electrode body 10 of the present embodiment is accommodated in the case 20 so that the rolling axis L of the electrode body 10 extends in the longitudinal direction of the rectangular lid 22 (lateral direction in FIG. 1). In this state, the uncoated portion 39P of the electrode sheet 35P, which forms the positive electrode 3, is connected to the positive electrode terminal 38P by a connecting member 40P. In the same manner, the uncoated portion 39N of the electrode sheet 35N, which forms the negative electrode 4, is connected to the negative electrode terminal 38N by a connecting member 40N.

An electrolyte solution 41 is injected into the case 20. In the electrolyte solution 41 of the rechargeable battery 1, which serves as a lithium-ion battery, lithium salt, which serves as support salt, is dissolved in an organic solvent. The electrode body 10 of the rechargeable battery 1 is immersed in the electrolyte solution 41 inside the case 20 of which the open end 21x is closed by the lid 22.

### Mixture Layer and Insulation Layer

As shown in FIG. 4, in the rechargeable battery 1 of the present embodiment, the electrode active material layer 32 on the electrode sheet 35 of the electrode body 10 defines a mixture layer 50 formed by applying a mixture paste 37, which contains an electrode active material, to a substrate 36 that serves as the collector 31.

More specifically, the electrode sheet 35 shown in FIG. 4 is the electrode sheet 35P for the positive electrode 3 including the positive electrode active material layer 32P formed on the substrate 36P that serves as the positive electrode collector 31P. Further, the electrode sheet 35 includes an insulation layer 60 applied to the substrate 36 adjacent to the mixture layer 50. The insulation layer 60 partially covers the uncoated portion 39 that is located at a lateral end of the electrode sheet 35. The electrode sheet 35 is a strip of foil. In the rechargeable battery 1 of the present embodiment, the insulation layer 60 is formed by applying an insulation paste 61, which contains an insulative material, to the substrate 36.

In the rechargeable battery 1 of the present embodiment, the mixture paste 37 and the insulation paste 61 are simultaneously applied to the substrate 36. The mixture paste 37 and the insulation paste 61 are dried to form the mixture layer 50 and the insulation layer 60 adjacent to each other on the substrate 36.

### Interfacial Region and Undulations in Interfacial Surface

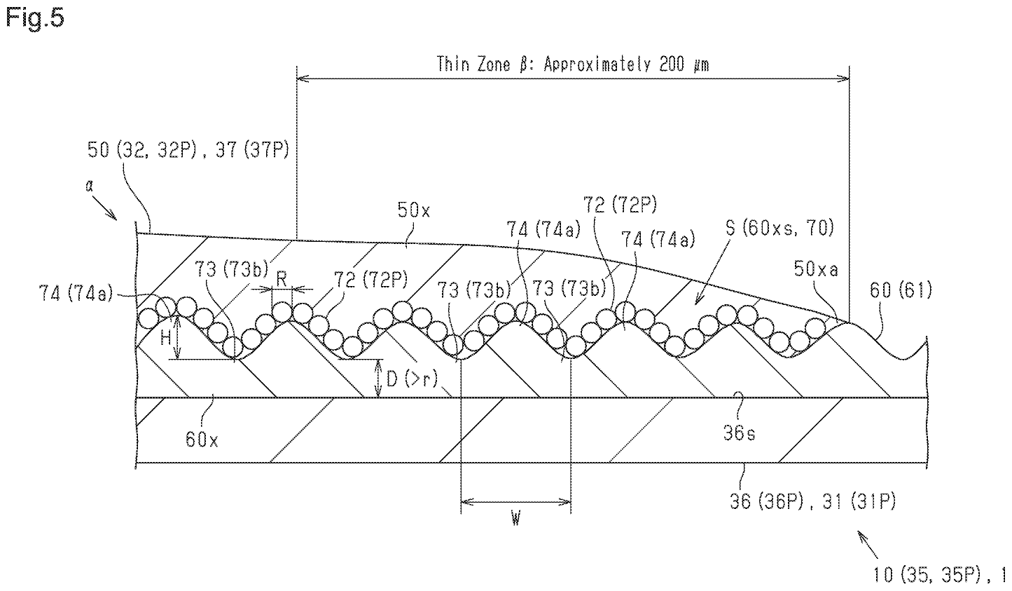

As shown in FIGS. 4 and 5, in the electrode sheet 35 of the present embodiment, the insulation layer 60x covers the surface 36s of the substrate 36 in an interfacial region a where the mixture layer 50 and the insulation layer 60 are located adjacent to each other. Further, in the interfacial region a, the mixture layer 50x extends over and overlaps the insulation layer 60x. In the electrode sheet 35 of the present embodiment, an upper surface 60xs of the insulation layer 60x defines an interfacial surface S interfacing the mixture layer 50x, which is formed above the insulation layer 60x.

Further, in the electrode sheet 35 of the present embodiment, the upper surface 60xs of the insulation layer 60x defining the interfacial surface S, which interfaces the mixture layer 50x, includes undulations 70, each having an undulation width W that is greater than a particle size R of an electrode active material 72 contained in the mixture layer 50x (W>R). In the electrode sheet 35 of the present embodiment, the undulations 70 increase the surface area of the insulation layer 60x contacting the mixture layer 50x. The increased area of contact between the insulation layer 69X and the mixture layer 50X increases the adhesion strength of the mixture layer 50x on the insulation layer 60x. This mitigates delamination of the insulation layer 60x in the interfacial region a.

Adhesion strength may also be referred to as delamination resistance or bonding strength. The undulation width W in the insulation layer 60x at the interfacial surface S interfacing the mixture layer 50x may be measured with, for example, a scanning electron microscope (SEM). More specifically, an image of the cross section of the interfacial region a between the mixture layer 50 and the insulation layer 60 is captured. FIGS. 4 and 5 are diagrams showing the captured image of the cross section of the interfacial region a. The cross-sectional image can be analyzed to measure the undulation width W that is the distance between two adjacent valleys 73, more specifically, the distance between the troughs 73b of the valleys 73.

The undulations 70 are arranged randomly in the interfacial surface S of the insulation layer 60x interfacing the mixture layer 50x. In the electrode sheet 35 of the present embodiment, the undulation width W is used as an index indicating the size of the undulations 70.

In the electrode sheet 35 of the present embodiment, the particle size R of the electrode active material 72 contained in the mixture layer 50, for example, ranges from 3 μm to 5 μm, inclusive. This range is for a case in which the electrode sheet 35 is the electrode sheet 35P of the positive electrode 3, that is, when the mixture layer 50 contains positive electrode active material 72P. The undulation width W in the interfacial surface S ranges from 40 μm to 80 μm, inclusive. The range of the undulation width W is 10 to 20 times greater than the particle size R of the electrode active material 72.

The adhesion strength of the mixture layer 50x on the insulation layer 60x increases as the area of contact between the mixture layer 50x and the insulation layer 60x increases. The contact area is enlarged by forming the fine undulations 70 in the interfacial surface S.

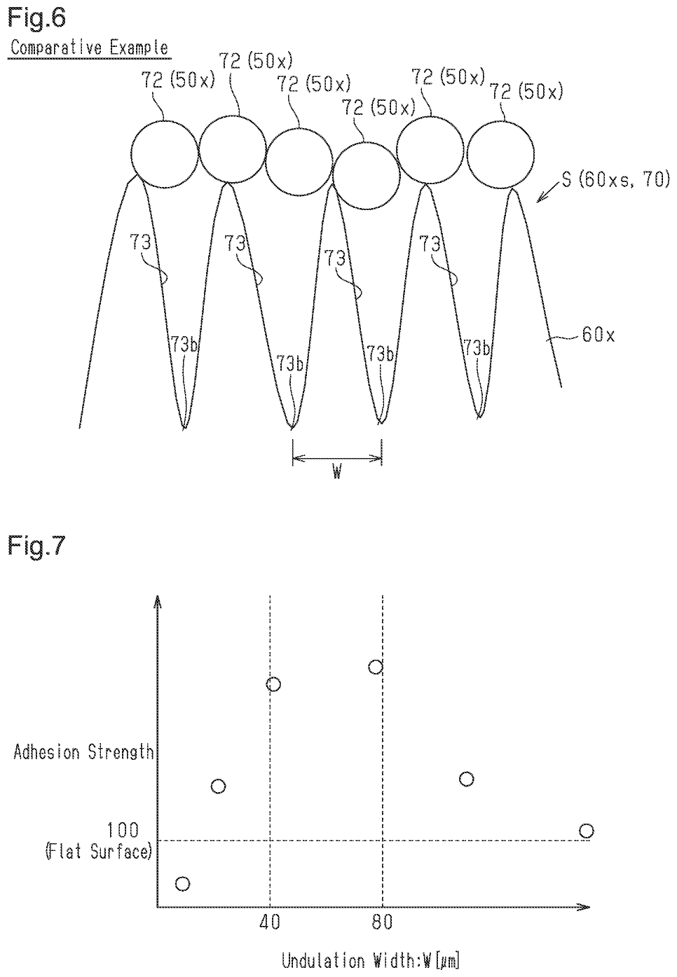

As shown in FIG. 6, when the undulation width W in the interfacial surface S is too narrow, the electrode active material 72 that enters the valleys 73 will be limited. The force binding the mixture layer 50x to the insulation layer 60x is produced by the binder contained in the mixture layer 50x. The binder is adhered to the electrode active material 72 in the mixture layer 50x (not shown). Thus, when the electrode active material 72 in the mixture layer 50x cannot enter the valleys 73 of the undulations 70, the substantial contact area between the insulation layer 60x and the mixture layer 50x will be smaller than when the interfacial surface S is flat. This will decrease the force binding the mixture layer 50x to the insulation layer 60x. In such a case, the adhesion strength will not be improved.

As shown in FIG. 7, when the particle size R of the electrode active material 72 contained in the mixture layer 50 is equivalent to that of the electrode sheet 35 of the present embodiment, the adhesion strength will be improved when the undulation width W in the interfacial surface S ranges from about 10 μm to 150 μm, inclusive. The lower limit of the undulation width W may be set to 20 μm or 40 μm. The upper limit of the undulation width W may be set to 120 μm or 80 μm.

FIG. 7 shows the adhesion strength relative to the undulation width W in the interfacial surface S, where 100 corresponds to a case in which the interfacial surface S of the insulation layer 60x interfacing the mixture layer 50x is a flat surface. The lower limits of 10 μm, 20 μm, and 40 μm for the undulation width W are respectively about 2.5 times, 5 times, and 10 times the particle size R of the electrode active material 72. The upper limits of 150 μm, 120 μm, and 80 μm for the undulation width W are respectively about 37.5 times, 30 times, and 20 times the particle size R of the electrode active material 72. In the electrode sheet 35 of the present embodiment, the range of the undulation width W is set based on the experimental results shown in FIG. 7.

Further, the adhesion strength is improved when the undulations 70 occupy approximately 20% or more of the interfacial surface S of the insulation layer 60x interfacing the mixture layer 50x. As the proportion of the undulations 70 increases, the adhesion strength will increase more prominently. Quality stability may be affected when the proportion of the undulations 70 is, for example, 70% or greater. Preferably, the undulations 70 occupy 30% or more of the interfacial surface S or 50% or more of the interfacial surface S. The electrode sheet 35 of the present embodiment has the preferred proportion of the undulations 70 in the interfacial surface S of the insulation layer 60x interfacing the mixture layer 50x.

With reference to FIG. 5, the insulation layer 60x has a thickness D at the troughs of the undulations 70, or the troughs 73b of the valleys 73, that is greater than the particle size r of the insulative material (not shown) contained in the insulation layer 60x (D>r). The insulative property of the insulation layer 60x will be adversely affected if there is a portion having no insulative material. Thus, in the electrode sheet 35 of the present embodiment, the thickness D of the insulation layer 60x at the troughs 73b of the valleys 73 is set to, for example, 2 μm or greater. The particle size of boehmite, which is the insulative material, is approximately 1 μm to 3 μm, inclusive. The thickness D of the insulation layer 60x at the troughs of the undulations 70 is set based on the particle size r of the insulative material. Thus, in the electrode sheet 35 of the present embodiment, the insulation layer 60x including the undulations 70 in the interfacial surface S interfacing the mixture layer 50x functions properly as the insulation layer 60.

The undulations 70 have a height H that is the difference between the troughs 73b of the valleys 73 and the crests 74a of the ridges 74 in the thickness direction of the insulation layer 60x. In the electrode sheet 35 of the present embodiment, the height H of the undulations 70 is approximately 3 times the particle size R of the electrode active material 72.

In the electrode sheet 35 of the present embodiment, the insulation layer 60x in the interfacial region a includes the undulations 70 that are arranged in the interfacial surface S within a range of approximately 200 μm from a distal end 50xa of the mixture layer 50x extending over and overlapping the insulation layer 60x.

In the interfacial region a, the mixture paste 37, when applied, will become thinner as it spreads when forming the mixture layer 50x. The mixture paste 37 will dry quickly at such a thin portion and cause uneven distribution of the binder in the mixture layer 50x. This may lower the adhesion strength of the mixture layer 50x.

In the electrode sheet 35 of the present embodiment, a thin zone R where the adhesion strength is low is apt to be formed within 200 μm from the distal end 50xa of the mixture layer 50x. Thus, in the electrode sheet 35 of the present embodiment, the thin zone R includes the undulations 70, which are formed in the interfacial surface S of the insulation layer 60x interfacing the mixture layer 50x. This effectively increases the adhesion strength of the mixture layer 50.

### Manufacturing Process

In the rechargeable battery 1 of the present embodiment, when manufacturing the electrode sheet 35P for the positive electrode 3 as the electrode sheet 35 of the electrode body 10, the viscosity of the insulation paste 61 is set, for example, in the range of 1000 to 5000 mPa·s, inclusive. The base temperature when measuring the viscosity is 25° C. The solid rate of the insulation paste 61 is set, for example, in the range of 10% to 40%, inclusive. Further, the viscosity of the mixture paste 37P for the positive electrode 3 is set, for example, in the range of 100 mPa·s to 20000 mPa·s, inclusive. The solid rate of the mixture paste 37P is set, for example, in the range of 60% to 70%, inclusive.

The mixture layer 50 and the insulation layer 60 are formed by simultaneously applying the mixture paste 37 and the insulation paste 61 to the substrate 36. The discharge rate of the mixture paste 37P is set, for example, in the range of 500 g/min to 2000 g/min, inclusive. The discharge rate of the insulation paste 61 is set, for example, in the range of 10 g/min to 100 g/min, inclusive.

When applying the mixture paste 37 and the insulation paste 61, the viscosity of the insulation paste 61 is set to be lower than the viscosity of the mixture paste 37. Since the insulation paste 61 has high fluidity, the insulation paste 61 applied to the substrate 36 will easily spread on the substrate 36. Thus, in the electrode sheet 35 of the present embodiment, the interfacial region a of the mixture layer 50 and the insulation layer 60 is formed so that the mixture layer 50x extends over and overlaps the insulation layer 60x, which covers the surface 36s of the substrate 36.

Further, in the electrode sheet 35 of the present embodiment, the undulations 70 are formed in the interfacial surface S of the insulation layer 60x interfacing the mixture layer 50x in accordance with the specification of the materials described above and the manufacturing conditions such as the temperature. The specification of the materials include, for example, the particle size R of the electrode active material 72 and the particle size r of the insulative material. These parameters are tailored in the electrode sheet 35 of the present embodiment to optimize the undulations 70 formed in the interfacial surface S of the insulation layer 60x.

### Operation

The arrangement of the undulations 70 in the interfacial surface S of the insulation layer 60x interfacing the mixture layer 50x enlarge the area of contact between the mixture layer 50x and the insulation layer 60x. The enlarged contact area increases the force binding the mixture layer 50x to the insulation layer 60x. This mitigates delamination of the mixture layer 50x, which extends over and overlaps the insulation layer 60x, in the interfacial region a of the mixture layer 50 and the insulation layer 60.

The advantages of the present embodiment will now be described.

(1) The electrode sheet 35 in the electrode body 10 of the rechargeable battery 1 includes the substrate 36 serving as the collector 31, the mixture layer 50 formed on the substrate 36 and containing the electrode active material 72, and the insulation layer 60 formed on the substrate 36 adjacent to the mixture layer 50 and containing the insulative material. Further, in the interfacial region a of the mixture layer 50 and the insulation layer 60, the mixture layer 50x extends over and overlaps the insulation layer 60x that covers the surface 36s of the substrate 36. The undulation width W of the undulations 70, which are arranged in the interfacial surface S where the insulation layer 60 interfaces the mixture layer 50x, is greater than the particle size R of the electrode active material 72.

The insulation layer 60x, which functions to increase the binder content ratio, covers the surface 36s of the substrate 36 so that the insulation layer 60x can be strongly bonded to the substrate 36 in the interfacial region a of the mixture layer 50 and the insulation layer 60. Further, the arrangement of the fine undulations 70 in the interfacial surface S increases the area of contact between the insulation layer 60x and the mixture layer 50x. This increases the force binding the mixture layer 50x to the insulation layer 60x. Thus, the interfacial region a has a high adhesion strength.

The undulation width W in the interfacial surface S is greater than the particle size R of the electrode active material 72. This allows the electrode active material 72 of the mixture layer 50x to enter the valleys 73 smoothly. The binder is adhered to the electrode active material 72 in the mixture layer 50x. This effectively increases the area of contact between the insulation layer 60x and the mixture layer 50x. As a result, the mixture layer 50x is strongly bonded to the insulation layer 60x, and the adhesion strength is further increased.

(2) To improve the adhesion strength, the undulation width W in the interfacial surface S is set, for example, ranging from 10 μm to 150 μm, inclusive, or from 20 μm to 120 μm, inclusive. The adhesion strength can be further improved if the undulation width W is set ranging from 40 μm to 80 μm, inclusive.

(3) To increase the adhesion strength, the undulation width W is set, for example, ranging from 2.5 to 40 times the particle size R of the electrode active material 72 or 5 to 40 times the particle size R. The adhesion strength can be further improved if the undulation width W is set ranging from 10 to 20 times the particle size R.

(4) The undulations 70 occupy 20% or more of the interfacial surface S or 30% or more of the interfacial surface S. The undulations 70 may occupy 50% or more of the interfacial surface S. This enlarges the area of contact between the mixture layer 50x and the insulation layer 60x and increases the adhesion strength.

(5) The thickness D of the insulation layer 60x at the troughs 73b of the valleys 73, or the troughs of the undulations 70, is greater than the particle size R of the insulative material contained in the insulation layer 60x (D>r).

This allows the insulative material to be arranged at the troughs of the undulations 70 where the thickness D of the insulation layer 60x is decreased. Thus, the insulation layer 60x including the undulations 70 in the interfacial surface S interfacing the mixture layer 50x functions properly as the insulation layer 60.

(6) The electrode sheet 35 includes the undulations 70 that are arranged in the interfacial surface S between the insulation layer 60x and the mixture layer 50x within a range of 200 μm from the distal end 50xa of the mixture layer 50x extending over and overlapping the insulation layer 60x.

In the interfacial region a, the applied mixture paste 37 spreads and reduces the thickness of the mixture layer 50x. This causes uneven distribution of the binder that may lead to delamination of the mixture layer 50x. In this respect, the interfacial surface S of the insulation layer 60x interfacing the mixture layer 50x includes the undulations 70 in the thin zone J. This increases the adhesion strength of the mixture layer 50 in the interfacial region a effectively.

The above embodiment may be modified as described below. The above embodiment and the modified examples described below may be combined as long as there is no technical contradiction.

The undulation width W may be set in any range. The upper limit of the undulation width W may be changed. The lower limit of the undulation width W may be changed. The upper and lower limits of the undulation width W may be changed. The thickness D of the insulation layer 60x at the troughs of the undulations 70 and the height H of the undulations 70 may be freely changed.

The interfacial surface S of the insulation layer 60x interfacing the mixture layer 50x may include a flat portion. The interfacial surface S does not have to entirely include the undulations 70. The proportion of the undulations 70 occupying the interfacial surface S may be freely changed.

In the above embodiment, the mixture paste 37 and the insulation paste 61 are simultaneously applied to the substrate 36 but do not have to be simultaneously supplied. The conditions for forming the mixture layer 50 and the insulation layer 60 may be freely changed.

The interfacial region a of the mixture layer 50 and the insulation layer 60 is formed in a state in which the mixture layer 50x extends over and overlaps the insulation layer 60x that covers the surface 36s of the substrate 36. It is only required that the undulation width W of the undulations 70 arranged in the interfacial surface S of the insulation layer 60 interfacing the mixture layer 50x be greater than the particle size R of the electrode active material 72. Thus, the details of the process for forming the mixture layer 50 and the insulation layer 60 may be freely changed as long as reproducibility can be obtained under the same conditions.

The above embodiment illustrates a preferred structure of the interfacial region a in the stack of the mixture layer 50 and the insulation layer 60 formed on the substrate 36 exemplified with the electrode sheet 35P for the positive electrode 3 including the positive electrode active material layer 32P formed on the substrate 36P serving as the positive electrode collector 31P. The same structure may be applied to the electrode sheet 35N for the negative electrode 4 including the negative electrode active material layer 32N formed on the substrate 36N serving as the negative electrode collector 31N.

The composition of mixture paste 37 and the insulation paste 61 including the electrode active material, the insulative material, and the binder may be changed.

In the above embodiment, the stack of the positive and negative electrode sheets 35P and 35N is rolled with the separators 5 held in between to form the electrode body 10. Instead, the electrode body 10 may be a stack of electrode plate groups. The rechargeable battery 1 to which the electrode body 10 is applied does not necessarily have to be a lithium-ion battery and may be another type of a non-aqueous electrolyte rechargeable battery. The structure described above may also be applied to a rechargeable battery other than a non-aqueous electrolyte rechargeable battery.

The external terminals do not have to be shaped as shown in FIG. 1 and may have any shape. The case 20, which forms the shell of the rechargeable battery 1, does not need to have the form of a flattened box and may have any form such as the form of a cylinder.

Technical concepts that can be recognized from the above embodiments and modified examples will now be described.
(A) The undulation width is 10 μm or greater.
(B) The undulation width is 40 μm or greater.
(C) The undulation width is 150 μm or less.
(D) The undulation width is 80 μm or less.

Each of these concepts increases the adhesion strength in the interfacial region.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An electrode body, comprising:
a substrate serving as a collector;
a mixture layer formed on the substrate and containing an electrode active material; and
an insulation layer formed on the substrate adjacent to the mixture layer, the insulation layer containing an insulative material,
wherein in an interfacial region of the mixture layer and the insulation layer, the mixture layer extends over and overlaps the insulation layer that covers a surface of the substrate, and an interfacial surface of the insulation surface interfacing the mixture layer includes undulations having an undulation width that is greater than a particle size of the electrode active material.

2. The electrode body according to claim 1, wherein the undulation width ranges from 5 to 30 times the particle size.

3. The electrode body according to claim 1, wherein the undulation width ranges from 20 to 120 μm, inclusive.

4. The electrode body according to claim 1, wherein the undulations occupy 20% or more of the interfacial surface.

5. The electrode body according to claim 1, wherein the insulation layer has a thickness at troughs of the undulations that is greater that the particle size of the insulative material.

6. The electrode body according to claim 1, wherein the undulations are arranged within a range of 200 μm from a distal end of the mixture layer extending over and overlapping the insulation layer.

7. The electrode body according to claim 1, wherein the mixture layer is a positive electrode active material layer.

8. A rechargeable battery comprising the body electrode according to claim 1.
